(19) United States
(12) Patent Application Publication
(10) Pub. No.: US 2011/0173250 A1
(43) Pub. Date: Jul. 14, 2011

(54) INFORMATION PROCESSING SYSTEM, CONTROL METHOD THEREFOR AND PROGRAM

(75) Inventor: Tomoya Sato, Kawasaki-shi (JP)

(73) Assignee: CANON KABUSHIKI KAISHA, Tokyo (JP)

(21) Appl. No.: 12/918,893

(22) PCT Filed: Jul. 14, 2010
(86) PCT No.: PCT/JP2010/062283

§ 371 Date: Aug. 23, 2010

(30) Foreign Application Priority Data
Aug. 5, 2009 (JP) 2009-182893

(51) Int. Cl. G06F 15/16

(52) U.S. Cl. 709/203

(57) ABSTRACT

An information processing system is provided that standardizes operations performed in cases where a hard key is pressed, irrespective of whether a Web application provided by an external apparatus or a native application of its own is executed. To accomplish this, the information processing system includes a server having a Web server function and an information processing apparatus having a Web browser function. When an operation screen is requested from the information processing apparatus and any hard key on the information processing apparatus is pressed during display of the operation screen, the server designates the information processing apparatus to perform a request with a predetermined URL by the Web browser function. The information processing apparatus registers the information designated by the server into a memory, and when any hard key is pressed during display of the operation screen, causes the Web browser function to perform the request.

### TECHNICAL FIELD

The present invention relates to an information processing system that includes a server and a browser for displaying an operation screen provided by the server, a control method therefor, and a program.

### BACKGROUND ART

Connecting an information processing apparatus such as a PC to a Web server on the network and displaying an operation screen provided by the Web server on a Web browser of the information processing apparatus is a known technique. In this case, the Web browser of the information processing apparatus requests the operation screen from the Web server. Meanwhile, in response to such a request from the information processing apparatus, a Web application on the Web server transmits to the information processing apparatus an HTML file for causing the Web browser to display the operation screen. The Web browser of the information processing apparatus analyzes the received HTML file and displays the operation screen based on the description of the received HTML file. Thereafter, if the user inputs an instruction from the operation screen displayed by the Web browser, the Web browser notifies the Web server of the input instruction. Then, the Web application on the Web server, which has received this notification, executes processing in accordance with the input instruction.

Incidentally, some recent MFPs equipped with a scanner, a printer, and the like also include a Web browser as described above. For example, Japanese Patent Laid-Open No. 2006-127503 has proposed a technique for providing, by a Web server, an operation screen from which the user inputs instructions to use the functions of an MFP. Specifically, if the user instruction is input from the operation screen displayed by the Web browser of an MFP, the Web server, having received notification, requests the MFP to execute a variety of processing in accordance with the contents of the user input instruction. The MFP, having received the request, executes the requested processing. This eliminates the need to store all menu data within the MFP in order to operate the MFP and also facilitates updates of menu data on the Web server.

However, the following problem arises with the conventional technique. In some information processing apparatuses such as MFPs as described above, some application screens are provided by their Web servers, whereas other application screens are provided by reading and executing programs stored in the MFPs. Hereinafter, applications provided by Web servers are referred to as “Web applications”, and applications executed based on pre-stored information in MFPs are referred to as “native applications”. One example is an MFP in which a copy function is provided as a native application and a scan function is provided as a Web application. With such an MFP, it is also desirable to provide the same operability without the user being aware of which application is a Web application and which application is a native application.

But, in the case of hard-key operations within the MFP, it was not able to provide the same operability with both native applications and Web applications. This is because, although input using buttons or the like on the operation screen displayed by the Web browser can be handled on the Web application side, input using hard keys cannot be handled on the Web application side. For example, in a case where a reset key, which is one of the hard keys provided on the MFP, is pressed during operation of the copy function provided as a native application, resetting of the copy function is performed and an initial screen of the copy function is displayed. On the other hand, in a case where the reset key is pressed during operation of the scan function provided as a Web application, resetting of the Web browser is performed and the homepage set for the Web browser is displayed. This shows a difference in operability from the copy function, thus causing inconvenience to the user who expects, with the press of the reset key, that the scan function will be reset and the initial screen of the scan function will be displayed.

### SUMMARY OF INVENTION

The present invention enables realization of an information processing system that standardizes operation performed in cases where a hard key is pressed, irrespective of whether a Web application provided by an external apparatus or a native application of its own is executed, as well as realization of a control method therefor and a program.

One aspect of the present invention provides an information processing system comprising an external apparatus having a server function and an information processing apparatus having a browser function, the external apparatus comprising: transmission means for, in response to a request from the information processing apparatus, transmitting screen information about an operation screen to be displayed by the information processing apparatus, and designation means for designating the information processing apparatus to perform, when predetermined input means out of a plurality of input means provided on the information processing apparatus is operated during display of the operation screen, a request with a predetermined URL by the browser function, the information processing apparatus comprising: request means for requesting an operation screen from the external apparatus; registration means for receiving the screen information from the external apparatus in response to the request for the operation screen and registering information designated by the designation means in a storage unit of the information processing apparatus; display means for displaying the operation screen on a display unit, based on the received screen information; and processing means for causing, based on the information registered in the storage unit, the browser function to perform the request with the predetermined URL when the predetermined input means is operated during display of the operation screen.

Another aspect of the present invention provides a method for controlling an information processing system that comprises an external apparatus having a server function and an information processing apparatus having a browser function, the external apparatus executing; a transmission step of, in response to a request from the information processing apparatus, transmitting screen information about an operation screen to be displayed by the information processing apparatus; and a designation step of designating the information processing apparatus to perform, when predetermined input means out of a plurality of input means provided on the information processing apparatus is operated during display of the operation screen, a request with a predetermined URL by the browser function, the information processing apparatus executing: a request step of requesting an operation screen from the external apparatus; a registration step of receiving the screen information from the external apparatus in response to the request for the operation screen and registering information designated in the designation step in a storage unit of the information processing apparatus; a display step of displaying the operation screen on a display unit based on the received screen information; and a processing step of causing, based on the information registered in the storage unit, the browser function to perform the request with the predetermined URL when the predetermined input means is operated during display of the operation screen.

Still another aspect of the present invention provides a computer-readable storage medium storing a computer program for causing a computer to perform the method for controlling the information processing system.

Further features of the present invention will be apparent from the following description of exemplary embodiments with reference to the attached drawings.

### BRIEF DESCRIPTION OF DRAWINGS

FIG. 1 shows a configuration example of an information processing system 100 according to a first embodiment.

FIG. 2 is a block diagram showing a control structure of the information processing system 100 according to the first embodiment.

FIG. 3 is a block diagram showing a functional configuration of the information processing system 100 according to the first embodiment.

FIG. 4 is a flowchart showing a procedure for requesting an operation screen to be displayed by an MFP 101 according to the first embodiment.

FIG. 5 is a flowchart showing a procedure in a Web application 510 for responding to a request for an operation screen according to the first embodiment.

FIG. 6 is a flowchart showing a procedure performed by a service provider according to the first embodiment.

FIG. 7 is a flowchart showing a procedure performed by a table management unit 562 of a hard key entry processing module 560 according to the first embodiment.

FIG. 8 is a flowchart showing a procedure performed by an event processing unit 561 of the hard key entry processing module 560 according to the first embodiment.

FIG. 9 is a flowchart showing a procedure performed by a Web browser 540 when a hard key is pressed, according to the first embodiment.

FIG. 10 shows an example of an operation screen 1000 displayed on a display unit of the MFP 101 according to the first embodiment.

FIG. 11 shows the contents of a table 563 according to the first embodiment.

FIG. 12 shows the contents of a table 1200 according to a second embodiment.

FIG. 13 is a flowchart showing a procedure performed by an event processing unit 561 of a hard key entry processing module 560 according to the second embodiment.

### DESCRIPTION OF EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

### Hardware Configuration of Information Processing System

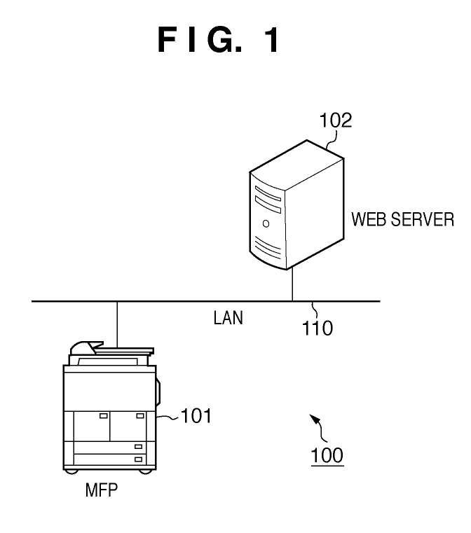

First, a hardware configuration of an information processing system according to a first embodiment is described with reference to FIG. 1. FIG. 1 shows a configuration example of an information processing system 100 according to the first embodiment. The information processing system 100 includes an MFP 101 having a Web browser function and a Web server 102 having a Web server function. Those apparatuses are connected so as to enable communication therebetween through a LAN 110. Note that the MFP 101 is one example of an information processing apparatus and the Web server 102 is one example of an external apparatus. The MFP 101 includes a display unit that displays a display screen of either a Web application provided by the Web server 102 or a native application pre-stored in the MFP 101, and an operation unit that includes multiple hardware keys (hereinafter referred to as “hard keys”). Note that the display unit may be a touch-panel LCD that displays software keys and is capable of accepting input using the software keys.

Control Structure of Information Processing System

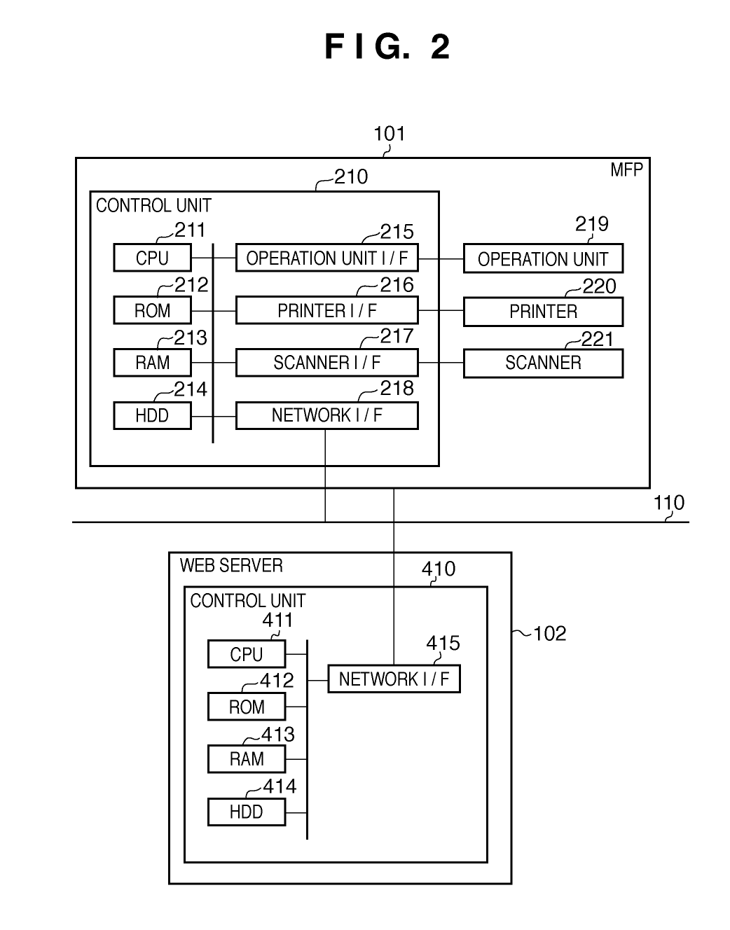

Next, a description is given of control structures of the MFP 101 and the Web server 102 with reference to FIG. 2. FIG. 2 is a block diagram showing a control structure of the information processing system 100 according to the first embodiment.

A control unit 210 including a CPU 211 has centralized control over the MFP 101. The CPU 211 executes a variety of control processing, such as reading control and transmission control, by reading control programs stored in a ROM 212. A RAM 213 is used as a main memory of the CPU 211 or a temporary storage area such as a work area. An HDD 214 stores image data, various programs, and various information tables described later. An operation unit interface (I/F) 215 provides connection between an operation unit 219 and the control unit 210. The operation unit 219 includes, for example, a liquid crystal display unit having a touch panel function, and a keyboard. Also, the MFP 101 has a Web browser function as described later, and a Web browser of the MFP 101 analyzes an HTML file received from the Web server 102 and displays an operation screen on the operation unit 219 based on the description of the received HTML file. The operation unit 219 includes an LCD display unit with a touch panel sheet stuck on the LCD. The LCD display unit displays an operation screen and software keys that are displayed by a native function module described later or the Web browser, and when a displayed key is pressed, transmits location information indicating the pressed position to the CPU 211.

The operation unit 219 is further provided with various hard keys such as a start key, a stop key, a reset key, a guide key, a top menu key, and numeric keys. The start key is a key for giving an instruction to start operation to read an image of an original, with its central portion being provided with a two-color (green and red) LED display unit. The two-color LED display unit indicates by its color whether the start key is enabled or not. The stop key is a key for stopping operation that is running. The reset key is a key used to initialize settings. The guide key is a key for displaying how to use the MFP 101. The top menu key is a key for displaying a top menu screen on which the functions of the MFP 101 are selected. The numerical-value keys are keys used to input numerical values.

A printer I/F 216 provides a connection between a printer 220 and the control unit 210. Image data to be printed by the printer 220 is transferred from the control unit 210 to the printer 220 through the printer I/F 216 and printed on a recording medium by the printer 220. A scanner I/F 217 provides a connection between a scanner 221 and the control unit 210. The scanner 221 generates image data by reading an image on an original and inputs the image data to the control unit 210 through the scanner I/F 217. A network I/F 218 provides connection between the control unit 210 and the LAN 110. The network I/F 218 transmits image data and information to an external apparatus (e.g., the Web server 102) on the LAN 110 and receives a variety of information from such an external apparatus on the LAN 110.

The Web server 102 includes a CPU 411 that has centralized control over the Web server 102. The CPU 411 executes a variety of control processing by reading control programs stored in a ROM 412. A RAM 413 is used as a main memory of the CPU 411 and a temporary storage area such as a work area. An HDD 414 stores image data, various programs, and various information tables. A network I/F 415 provides a connection between a control unit 410 and the LAN 110. The network I/F 415 receives and transmits a variety of information to and from other apparatuses on the LAN 110.

Functional Configuration of Information Processing System

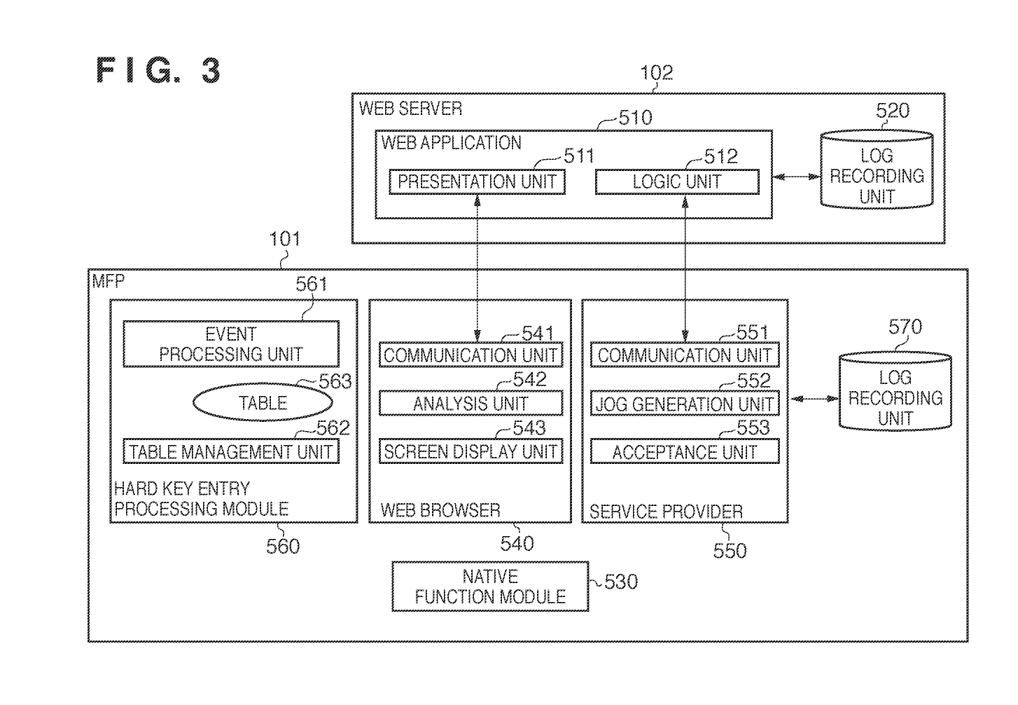

Next, a description is given of a functional configuration of the information processing system 100 with reference to FIG. 3. FIG. 3 is a block diagram showing the functional configuration of the information processing system 100 according to the first embodiment. The functional blocks shown in FIG. 3 are implemented by the CPUs 211 and 411 of the MFP 101 and the Web server 102, respectively, executing control programs.

The MFP 101 includes a native function module 530, a Web browser 540, a service provider 550, a hard key entry processing module 560, and a log recording unit 570. The native function module 530 represents various native applications that are provided not by the Web server 102 but based on programs stored within the MFP 101. Examples of such native applications include applications that execute print processing by the printer 220 of the MFP 101, reading processing by the scanner 221, and transmission processing through the network I/F 218. The native function module 530 also includes modules that perform settings of the entire MFP 101 and switching of applications, for example.

The Web browser 540 includes a communication unit 541, an analysis unit 542, and a screen display unit 543. The communication unit 541 communicates with a presentation unit 511 of a Web application 510 in accordance with the HTTP protocol. Specifically, the communication unit 541 requests the Web application 510 for an operation screen to be displayed by the Web browser 540 and notifies the Web application 510 of user instructions that have been input from the operation screen displayed by the Web browser 540. Also, upon receipt of notification from the hard key entry processing module 560 described later, the communication unit 541 requests the Web application 510 for the notified URL. The analysis unit 542 analyzes an HTML file received from the Web application 510. The HTML file contains descriptions (screen information) indicating the contents of the operation screen to be displayed by the Web browser 540. The screen display unit 543 displays the operation screen on the operation unit 219 based on results of the analysis by the analysis unit 542. Such a screen that is displayed based on the screen information (such as an HTML file) received from the Web server 102 is referred to as a “Web browser screen”.

The Web server 102 includes the Web application 510 and a log recording unit 520. The Web application 510 includes the presentation unit 511 and a logic unit 512. The presentation unit 511 communicates with the communication unit 541, and in response to a request from the MFP 101, transmits to the MFP 101 an operation screen to be displayed by the Web browser 540 of the MFP 101. It also receives from the MFP 101 a user instruction that has been input from the operation screen displayed by the Web browser 540 of the MFP 101.

The Web application 510, having received a user instruction, executes a variety of processing in accordance with the contents of the instruction, and requests the MFP 101 to transmit operation notification indicating that a hard key on the MFP 101 has been operated. Hereinafter, such a request is referred to as a “hard key entry notification request”. Specifically, when a hard key on the MFP 101 is pressed, the Web application 510 designates a URL to be requested from the Web browser 540 of the MFP 101. The Web application 510 also requests the MFP 101 to execute processing, according to the contents of the instruction. Specifically, it requests execution of print processing by the printer 220 of the MFP 101, execution of reading processing by the scanner 221, or execution of transmission processing through the network I/F 218.

In such a case where a predetermined hard key is operated during display of a predetermined operation screen and the MFP 101 is requested to make operation notification indicating the hard key operation or to execute processing, the logic unit 512 communicates with a communication unit 551 of the service provider 550. Then, results of the processing executed by the MFP 101 are recorded in the log recording unit 520. Note that the log recording unit 520 also records results of authentication processing performed by the Web server 102.

The service provider 550 of the MFP 101 includes the communication unit 551, a job generation unit 552, and an acceptance unit 553. The communication unit 551 accepts a process request from the logic unit 512 of the Web application 510. In a case where a request for hard key entry notification (operation notification) is received from the Web application 510, the acceptance unit 553 notifies the hard key entry processing module 560 of the received information. In a case where a request to execute processing is received from the Web application 510, the job generation unit 552 generates and executes a job for executing the requested processing. The execution results of the job are recorded in the log recording unit 570. Note that the log recording unit 570 also records a history of communications with the Web server 102, for example.

The hard key entry processing module 560 includes a table 563, a table management unit 562, and an event processing unit 561. The table management unit 562 receives notification from the acceptance unit 553 of the service provider 550 and registers the received information in the table 563. The table 563 manages URLs that are associated with hard keys and that are to be requested from the Web browser 540 when the press of a hard key is detected. Note that the table 563 is stored in a storage unit of the MFP 101 such as the RAM 213 or the HDD 214, for example.

The event processing unit 561 receives hard key entry notification from the operation unit 219 and gives notification to the Web browser 540 or the native function module 530 by referring to the table 563. For example, if the pressed hard key has a URL assigned in the table 563, the Web browser 540 is notified of that URL. On the other hand, if the hard key has no URL assigned, the native function module 530 is notified of the hard key entry. The native function module 530 performs predetermined processing corresponding to the notified hard key. Note that a part or the whole of the hard key entry processing module 560 may be configured as a submodule of the Web browser 540, the service provider 550, or the native function module 530.

Operation of Web Browser

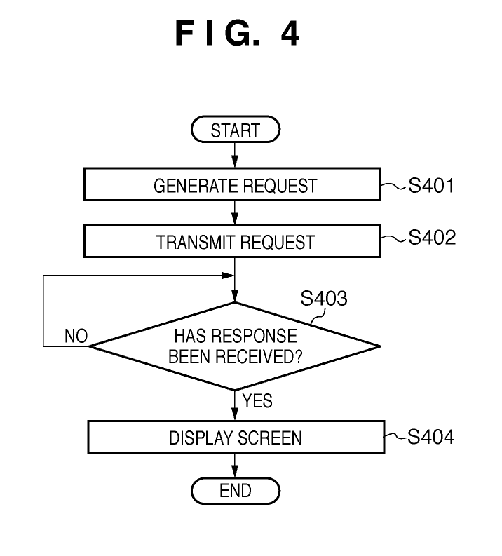

Next, a description is given of a process for the Web browser 540 to request an operation screen with reference to FIG. 4. FIG. 4 is a flowchart showing a procedure for requesting an operation screen to be displayed by the MFP 101 according to the first embodiment. The processing described below is executed by the Web browser 540, with the CPU 211 of the MFP 101 executing a control program. Note that the numbers following “S” described below denote the numbers of the steps in each process.

First, in S401, the Web browser 540 generates a request to request the Web server 102 for an operation screen to be displayed on the display unit of the MFP 101. This request may be in the form of a preset URL of the homepage or the like of the Web browser 540, a URL that has been input in a URL entry field of the Web browser 540 by the user, or a URL of a link selected by the user from the screen displayed by the Web browser 540. Subsequently, the Web browser 540 transmits the generated request to the Web server 102 in S402.

Thereafter, the Web browser 540 determines in S403 whether or not screen information about an operation screen has been transmitted from the Web server 102 in response to the transmitted request. Note that in actual operation, an HTML file or the like is transmitted from the Web server 102 as the screen information that causes the Web browser 540 to display an operation screen. Here, if the Web browser 540 has received the screen information about the operation screen, the process proceeds to S404, and if not, the process waits until the screen information is received. In S404, the Web browser 540 displays a screen on the display unit in accordance with the description of the received HTML file.

Operation of Web Application

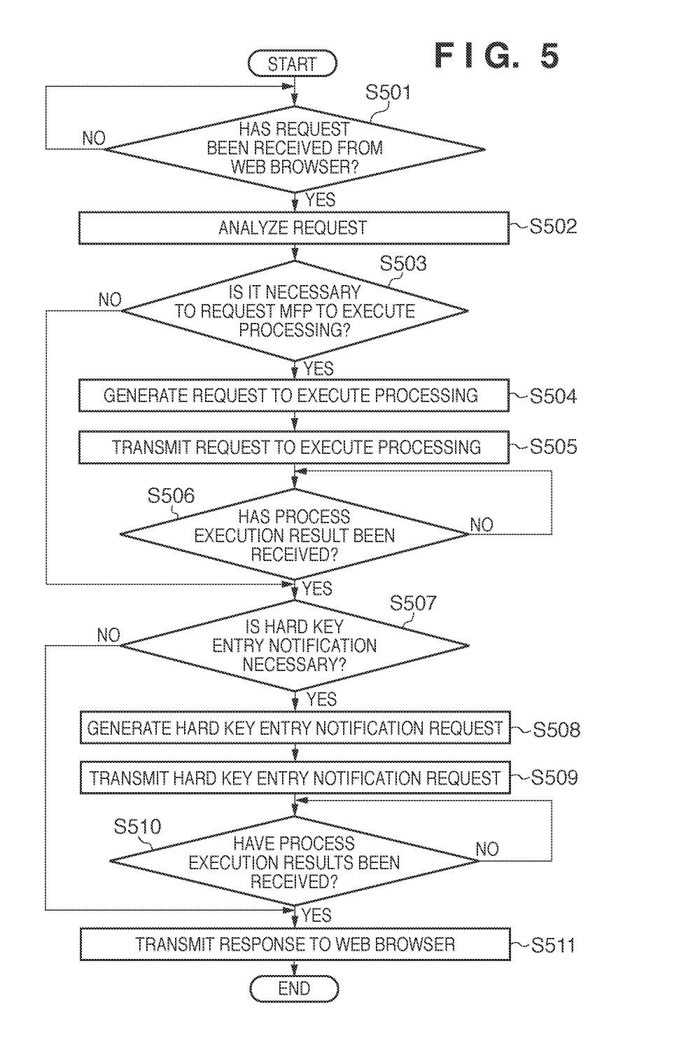

Next, a description is given of a response process performed by the Web server 102 in response to a request from the Web browser 540, with reference to FIG. 5. FIG. 5 is a flowchart showing a procedure performed by the Web application 510 in response to a request for an operation screen, according to the first embodiment. The processing described below is implemented by the CPU 411 of the Web server 102 executing a control program.

In S501, the Web application 510 determines whether or not a request for an operation screen has been received from the Web browser 540. If the request has been received, the process proceeds to S502, and if not, the process waits until the request is received. Upon receipt of the request, the Web application 510 analyzes the received request in S502. After the analysis of the request, the Web application 510 determines in S503 whether or not processing needs to be executed by the MFP 101. If the execution of processing by the MFP 101 is necessary, the process proceeds to S504, and if not, the process proceeds to S507.

In S504, the Web application 510 generates a process execution request to be given to the MFP 101, and then in S505, transmits the process execution request to the MFP 101. Thereafter, the Web application 510 determines in S506 whether or not results of the processing performed in response to the process execution request have been received from the MFP 101. If process execution results have been received, the process proceeds to S507, and if not, the process waits until process execution results are received.

In S507, the Web application 510 determines whether a hard key entry notification request is necessary or not based on the analysis results in S502 or the process execution results received in S506. If it is determined that the hard key entry notification request to the MFP 101 is necessary, the process proceeds to S508, and if not, the process proceeds to S511. In S508, the Web application 510 generates a hard key entry notification request to be given to the MFP 101, and then in S509, transmits the generated hard key entry notification request to the MFP 101. The hard key entry notification request generated in S508 includes a hard key type and information about a URL to be requested from the Web browser 540 when the press of the hard key is detected. Alternatively, the hard key entry notification request may include a hard key type and information about an instruction to return the processing being performed when the hard key was pressed to a default state.

Subsequently, the Web application 510 determines in S510 whether or not process execution results have been received from the MFP 101. If process execution results have been received, the process proceeds to S511, and if not, the process waits until process execution results are received. In S511, the Web application 510 transmits a response to the Web browser 540. In actual operation, this response is, for example, in the form of an HTML file that causes the Web browser 540 to display an operation screen based on the request from the Web browser 540.

Operation of Service Provider

Next, a description is given of processing performed by the service provider of the MFP 101 with reference to FIG. 6. FIG. 6 is a flowchart showing a procedure performed by the service provider according to the first embodiment. The processing described below is executed by the service provider 550, with the CPU 211 of the MFP 101 executing a control program.

In S601, the service provider 550 determines whether or not a request has been received from the Web server 102. If a request has been received from the Web server 102, the process proceeds to S602, and if not, the process waits until a request is received. In S602, the service provider 550 determines whether or not the request received from the Web server 102 is a hard key entry notification request. If the request is a hard key entry notification request, the process proceeds to S603, and if not, the process proceeds to S604.

If a hard key entry notification request has been received, the service provider 550 causes the acceptance unit 553 to instruct the hard key entry processing module 560 to update the table 563 in S603, and the process proceeds to S605. On the other hand, if the request is not a hard key entry notification request, the service provider 550 executes processing in accordance with the contents of the request in S604, and the process proceeds to S605. Specifically, the job generation unit 552 generates and executes a job for executing the requested processing. In S605, the service provider 550 transmits process execution results to the Web server 102.

Processing Relating to Press of Hard Key

Next, a description is given of processing performed by each module in relation to the press of a hard key on the MFP 101, with reference to FIGS. 7 to 9. First, the operation of the hard key entry processing module is described with reference to FIG. 7. FIG. 7 is a flowchart showing a procedure performed by the table management unit 562 of the hard key entry processing module 560 according to the first embodiment. The processing described below is implemented by the CPU 211 of the MFP 101 executing a control program.

In S701, the table management unit 562 of the hard key entry processing module 560 determines whether or not an instruction to update the table 563 has been received from the acceptance unit 553 of the service provider 550. This update instruction is an instruction notified by the processing of S603 in the flowchart shown in FIG. 6. If the update instruction has been received, the process proceeds to S702, and if not, the process waits until the request is received. In S702, the table management unit 562 performs updating of the table 563. The updating as referred to herein is performed, for example based on the information contained in the hard key entry notification request, that is, the hard key type and the information about a URL to be requested from the Web browser 540 when the press of a hard key is detected. In other words, the table 563 is updated so as to reflect the hard key entry notification request from the Web server 102.

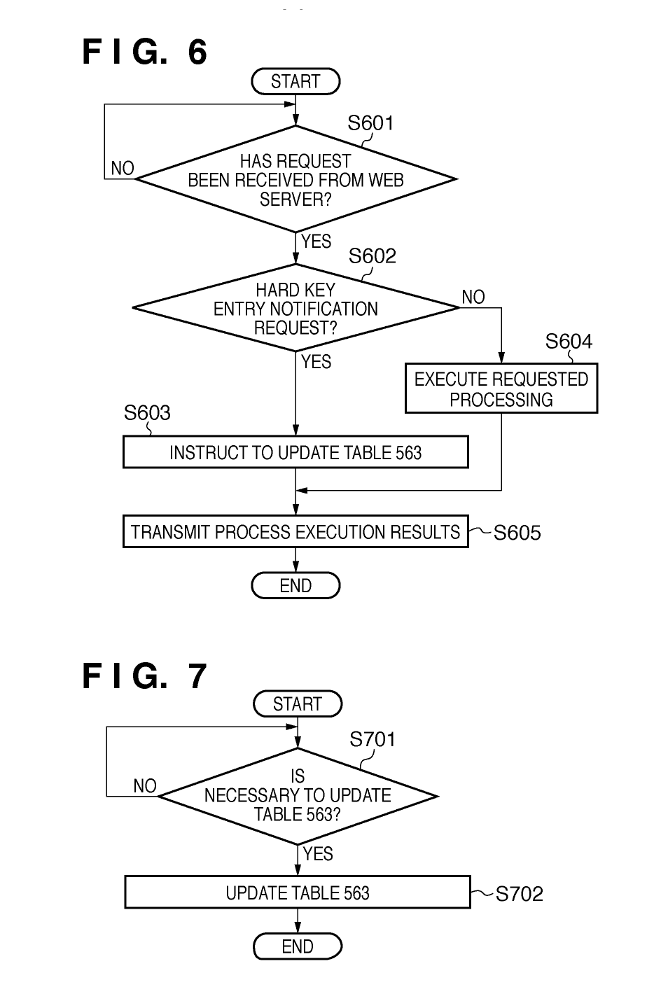

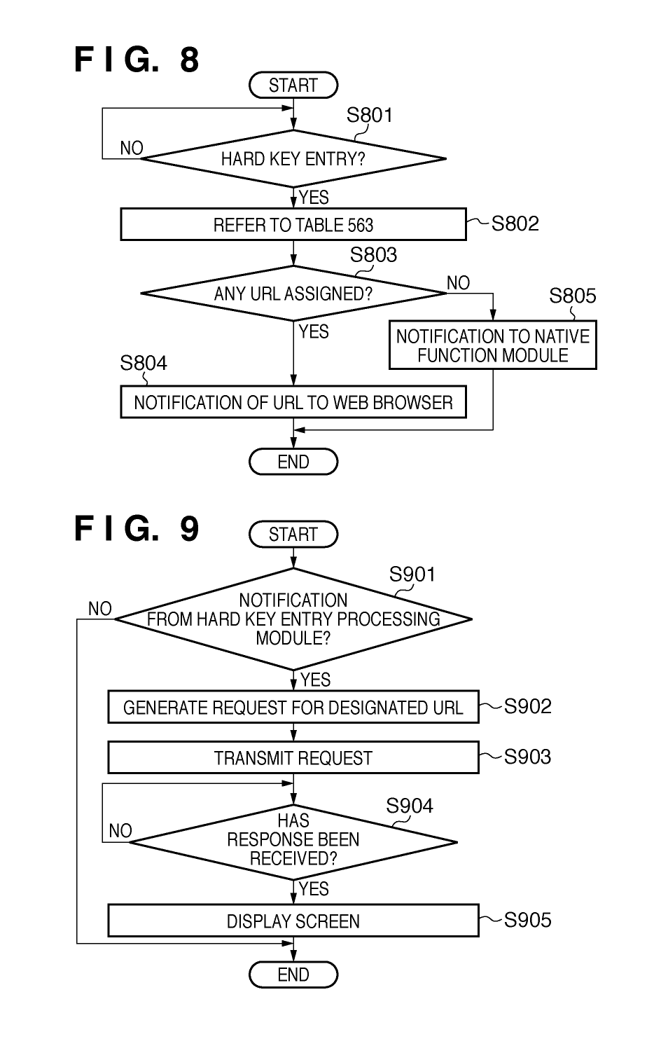

Next, a description is given of the operation of the hard key entry processing module 560 performed when a hard key on the MFP 101 is pressed, with reference to FIG. 8. FIG. 8 is a flowchart showing a procedure performed by the event processing unit 561 of the hard key entry processing module 560 according to the first embodiment. The processing described below is implemented by the CPU 211 of the MFP 101 executing a control program.

In S801, the event processing unit 561 determines whether or not a hard key press notification has been received from the operation unit 219. If the hard key press notification has been received, the process proceeds to S802, and if not, the process waits until the notification is received. In S802, the event processing unit 561 refers to the table 563 based on the hard key press notification. Further, in S803, the event processing unit 561 determines whether or not the hard key that was notified as having been pressed has a URL assigned, from results of the reference of the table 563. If the hard key has a URL assigned, the process proceeds to S804, and if the hard key has no URL assigned, the process proceeds to S805.

In a case where the hard key has a URL assigned, the event processing unit 561 notifies the Web browser 540 of that URL in S804 and completes the process. On the other hand, if the hard key has no URL assigned, the event processing unit 561 notifies the native function module 530 of the press of the hard key in S805 and completes the process. Here, the native function module 530, having received the hard key press notification, performs predetermined default processing for the hard key.

Next, a description is given of the operation of the Web browser 540 performed when a hard key on the MFP 101 is pressed, with reference to FIG. 9. FIG. 9 is a flowchart showing a procedure performed by the Web browser 540 when a hard key is pressed, according to the first embodiment. The processing described below is implemented by the CPU 211 of the MFP 101 executing a control program.

In S901, the Web browser 540 determines whether or not notification has been received from the hard key entry processing module 560. If notification has been received, the process proceeds to S902, and if not, the process ends. Note that the notification as referred to herein is the notification given by the processing of S804 in FIG. 8. In S902, the Web browser 540 generates an HTTP request to request a URL notified from the hard key entry processing module 560, and then in S903, transmits the generated request to the Web server 102.

Then, in S904, the Web browser 540 determines whether or not a response to the request has been received from the Web server 102. If the response has been received, the process proceeds to S905, and if not, the process waits until the response is received. In actual operation, this response is an HTML file. In S905, the Web browser 540 displays a screen on the display unit in accordance with the description of the received HTML file.

Operation Screen and Table

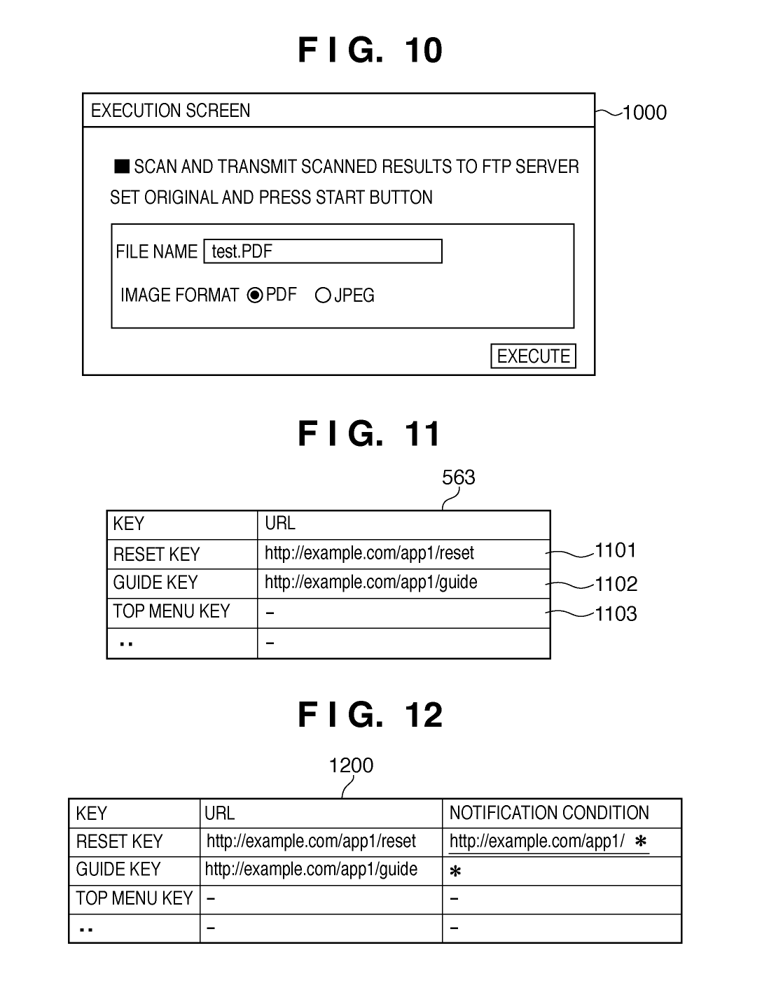

Next, a description is given of an example of the operation screen displayed on the display unit of the MFP 101 and the contents of the table 563, with reference to FIGS. 10 and 11. FIG. 10 shows an example of an operation screen 1000 displayed on the display unit of the MFP 101 according to the first embodiment. The operation screen 1000 is an example of the screen obtained such that the Web server 102 transmits an HTML file as a response to the Web browser 540 in S511 and then the Web browser 540 displays a screen with the operation unit based on the received HTML file in S404. The operation screen 1000 as referred to herein is an operation screen for a Web application that generates image data by reading an image on an original with the scanner 221 of the MFP 101 and gives an instruction to transmit the generated image data to an FTP server on the LAN 110.

As described above, the Web server 102 when returning the response makes a hard key entry notification request in S509. FIG. 11 shows the contents of the table 563 according to the first embodiment. The contents of the table 563 as shown herein shows an example in a case where the table has been updated by the table management unit 562 upon receipt of a hard key entry notification request from the Web server 102. Row 1101 in FIG. 11 indicates that the URL http://example.com/app1/reset is assigned to the reset key, which is one of the hard keys on the MFP 101. Similarly, row 1102 indicates that the URL http://example.com/app1/guide is assigned to the guide key. Row 1103 indicates that no URL is assigned to the top menu key.

With such updated table 563, for example if the reset key is pressed, the event processing unit 561 notifies the Web browser 540 of the URL http://example.com/app1/reset by referring to the table 563. Thereafter, the Web browser 540 requests the Web server 102 for the notified URL. Upon receipt of such a request, the Web application 510 of the Web server 102 performs resetting of the application and transmits a response to the Web browser 540. Accordingly, when the reset key is pressed, it is possible to reset the Web application 510 without performing resetting of the Web browser 540. This enables similar operation to be performed for each application when a predetermined hard key is pressed, without the user being aware of which one of the operation screens, either the one for a Web application or the one for a native application, is being displayed on the display unit.

As described above, the information processing system according to the present embodiment includes an external apparatus (Web server 102) having a Web server function and an information processing apparatus (MFP 101) having a Web browser function. When an operation screen is requested from the MFP 101 and a hard key is pressed during display of the operation screen, the Web server 102 instructs the MFP 101 to transmit to the Web server 102, operation notification indicating that fact. The MFP 101 registers information designated by the Web server 102 in a memory or the like, and when a hard key is pressed during display of the operation screen, determines whether or not the operation notification needs to be transmitted by referring to the registered information so as to determine subsequent processing. Note that the information designated by the Web server 102 may be information about an URL to be requested from the Web browser 540 when a hard key on the MFP 101 is pressed. In this case, when a hard key is pressed, the MFP 101 requests the Web application 510 for the designated URL through the Web browser 540. In this way, the information processing system according to the present embodiment is capable of controlling the processing performed when a predetermined hard key is pressed on the Web server 102 side, thus offering the user the same operability with both Web applications and native applications. In other words, the information processing system according to the present embodiment enables operation performed when a hard key is pressed to be standardized irrespective of whether a Web application provided by an external apparatus or its own native application is being executed.

### Second Embodiment

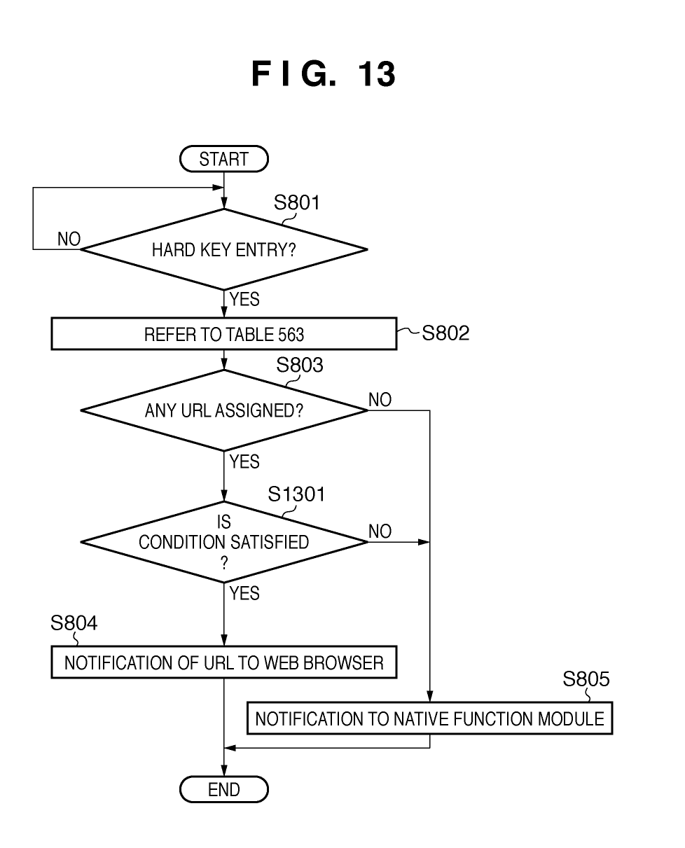

Next, a description is given of a second embodiment with reference to FIGS. 12 and 13. The present embodiment describes the case where a structure for designating a condition at the time of notifying the press of a hard key is further added to the structures described in the first embodiment. Note that the description here is given of only the structure and technique different from those of the first embodiment, and similar structures and techniques have not been described herein.

According to the present embodiment, a Web server 102 when transmitting a hard key entry notification request to the MFP 101 designates a screen displayed by the MFP 101 as a notification condition. Specifically, in S508 in FIG. 5, the Web server 102 generates a hard key entry notification request that contains a screen displayed by the MFP 101 as a notification condition, in addition to the hard key type and the information about an URL to be requested when the press of the hard key is detected. The notification condition as referred to herein is a condition that needs to be satisfied when a hard key is pressed in order to notify the Web application 510 of the press of the hard key. That is, when a hard key is pressed, the press of the hard key is notified only when the screen designated as a notification condition is displayed on the display unit of the MFP 101.

A service provider 550, upon receipt of the request containing such a notification condition, adds information about the condition at the time of giving an instruction to update a table 1200 described below to a hard key entry processing module 560. That is, information about the notification condition received from the Web server 102 is added to the instruction to update the table 1200 in S603 in FIG. 6.

The hard key entry processing module 560, having received the above instruction, updates the table 1200. FIG. 12 shows the contents of the table 1200 according to the second embodiment. The table 1200 is a modified example of the table 563 according to the first embodiment.

Here, the URL http://example.com/app1/reset is assigned to the reset key, on the notification condition of the URL http://example.com/app1/*. This indicates that, when the reset key is pressed, the URL http://example.com/app1/reset is requested if the Web browser 540 is displaying the URL http://example.com/app1/*. Here, the asterisk “*” designated within the notification condition refers to a wild card that could be any combination of characters. That is, in the case of the reset key shown in FIG. 12, the condition is treated as satisfied if part of the URL of the operation screen displayed by the Web browser 540 matches the URL http://example.com/app1/. If the condition is not satisfied, default processing of the hard key is executed. In the case of the guide key, the URL http://example.com/app1/guide is always requested without any condition.

Next, the operation of an event processing unit 561 of the hard key entry processing module 560 when a hard key on the MFP 101 is pressed according to the present embodiment will be described with reference to FIG. 13. FIG. 13 is a flowchart showing a procedure performed by the event processing unit 561 of the hard key entry processing module 560 according to the second embodiment. The processing described below is implemented by the CPU 211 of the MFP 101 executing a control program. Note that processing of S801 to S805 is similar to that shown in the flowchart of FIG. 8 and thus has not been described herein. The following description is given of only additional processing of S1301.

In S1301 where the pressed hard key has a URL assigned, the event processing unit 561 further determines whether or not the notification condition is satisfied. Specifically, it is determined whether or not the currently displayed screen satisfies the notification condition in the table 1200. If the condition is satisfied, the process proceeds to S804, in which the event processing unit 561 notifies the Web browser 540 of the URL and completes the process. On the other hand, when it has been determined in S803 that the hard key has no URL assigned or when it has been determined in S1301 that the condition is not satisfied, the process proceeds to S805, in which the event processing unit 561 notifies the native function module of the press of the hard key and completes the process. Note that, upon receipt of the hard key press notification, the native function module 530 performs predetermined processing for the hard key.

As described above, in the information processing system according to the present embodiment, when designating an URL to be requested from the Web browser 540 when a hard key on the MFP 101 is pressed, the Web server 102 also designates a notification condition on which the designation is applied. In this case, when a hard key is pressed, the MFP 101 causes the Web browser to request the designated URL only when transmission of an operation notification has been designated and a notification condition on which the designation is applied is satisfied. With this, the information processing system according to the present embodiment enables the Web server 102 to flexibly control the processing performed when a hard key is pressed, thus offering the same operability as in the case of native applications.

Note that the present embodiment is not limited to the above and various modifications are feasible. For example, while the above-described embodiment has shown an example in which, when a predetermined hard key is operated, the display of a predetermined operation screen on the display unit is established as a notification condition, the present invention is not limited thereto and it is also possible to use other states of the MFP 101 as a condition or to combine multiple conditions. For example, whether or not the user (operator) currently logged into the MFP 101 has predetermined authority may be used as a condition, or the condition that the MFP 101 is in a predetermined error state may be used.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-182893 filed on Aug. 5, 2009, which is hereby incorporated by reference herein in its entirety.

1. An information processing system comprising an external apparatus having a server function and an information processing apparatus having a browser function,
the external apparatus comprising:
transmission means for, in response to a request from the information processing apparatus, transmitting screen information about an operation screen to be displayed by the information processing apparatus, and
designation means for designating the information processing apparatus to perform, when predetermined input means out of a plurality of input means provided on the information processing apparatus is operated during display of the operation screen, a request with a predetermined URL by the browser function,
the information processing apparatus comprising:
request means for requesting an operation screen from the external apparatus;
registration means for receiving the screen information from the external apparatus in response to the request for the operation screen and registering information designated by the designation means in a storage unit of the information processing apparatus;
display means for displaying the operation screen on a display unit, based on the received screen information; and
processing means for causing, based on the information registered in the storage unit, the browser function to perform the request with the predetermined URL when the predetermined input means is operated during display of the operation screen.

2. The information processing system according to claim 1, wherein the designation means designates a type of the predetermined input means and URL information to be requested from the information processing apparatus when the predetermined input means is operated.

3. The information processing system according to claim 2, wherein, when the predetermined input means is operated during display of the operation screen, the processing means causes the browser function to request new screen information from the external apparatus in accordance with the URL information, and displays an operation screen on the display unit based on the new screen information received from the external apparatus in response to the request.

4. The information processing system according to claim 2,
wherein the designation means further designates a notification condition regarding the request with the predetermined URL by the browser function, and
the processing means causes the browser function to perform the request with the predetermined URL when the notification condition is satisfied.

5. The information processing system according to claim 4, wherein the notification condition includes at least one of the display unit displaying a predetermined operation screen when the predetermined input means is operated, an operator who is logged into the information processing apparatus having predetermined authority, and the information processing apparatus being in a predetermined error state.

6. The information processing system according to claim 1, wherein the predetermined input means is a hardware key provided on the information processing apparatus.

7. A method for controlling an information processing system that comprises an external apparatus having a server function and an information processing apparatus having a browser function,
the external apparatus executing;
a transmission step of, in response to a request from the information processing apparatus, transmitting screen information about an operation screen to be displayed by the information processing apparatus; and
a designation step of designating the information processing apparatus to perform, when predetermined input means out of a plurality of input means provided on the information processing apparatus is operated during display of the operation screen, a request with a predetermined URL by the browser function,
the information processing apparatus executing:
a request step of requesting an operation screen from the external apparatus;
a registration step of receiving the screen information from the external apparatus in response to the request for the operation screen and registering information designated in the designation step in a storage unit of the information processing apparatus;
a display step of displaying the operation screen on a display unit based on the received screen information; and
a processing step of causing, based on the information registered in the storage unit, the browser function to perform the request with the predetermined URL when the predetermined input means is operated during display of the operation screen.

8. A computer-readable storage medium storing computer program for causing a computer to perform the method for controlling an information processing system according to claim 7.
